(19) United States
(12) Patent Application Publication
(10) Pub. No.: US 2012/0151213 A1
(43) Pub. Date: Jun. 14, 2012

(54) Method and System for Managing Home Gateway Digital Certifications

(75) Inventor: Liang Xiao, Shenzhen (CN)

(73) Assignee: ZTE CORPORATION, Shenzhen City, Guangdong Province (CN)

(21) Appl. No.: 13/391,136

(22) PCT Filed: Sep. 3, 2010
(86) PCT No.: PCT/CN2010/076608

§ 371 Date: Feb. 17, 2012

(30) Foreign Application Priority Data
May 26, 2010 (CN) 201010186829.7

(51) Int. Cl. H04L 9/28

(52) U.S. Cl. 713/168

(57) ABSTRACT

The present invention discloses a method and system for managing digital certificates in a home gateway, the method comprising: a network management server sending certificate management information to the home gateway via the Technical Report-069.CPE WAN Management Protocol (TR069) packet, and remotely managing the digital certificates in the home gateway; after the home gateway receives the TR069 packet, it manages the digital certificates according to the certificate management information in the packet as follows: add digital certificates, update digital certificates, or delete digital certificates. With the technical solution of the present invention, the remote management for digital certificates in the home gateway can be achieved.

### TECHNICAL FIELD

The present invention relates to the field of communications technology, and more especially, to a method and system for managing digital certificates in a home gateway.

### BACKGROUND OF THE RELATED ART

Because of its security benefits, digital certificates have more and more front-end applications, and they are widely used in banking, Internet and other fields. Within the home gateway, due to some security requirements, a lot of functions are achieved based on digital certificates. For example, the encryption of the packets transmitted with the TR069 (Technical Report-069.CPE WAN Management Protocol) protocol, mutual authentication between the home gateway and the ACS (Auto-Configuration Server), the encryption of the wirelessly transmitted data, the encryption of the locally configured packets, all of which use the digital certificates.

The relatively common practice is that, when the home gateway is in production, the operators send the default digital certificates to the equipment manufacturers, and the equipment manufacturers preset the digital certificates into the home gateway, subsequently, the digital certificates can only be changed via the local WEB page. If the home gateway is placed at the user's home, the operators generally cannot replace the digital certificates in the home gateway. But the actual situation is, the operators likely need to update the digital certificates in the gateway, for example, when the digital certificates are about to expire, it needs to replace the encryption algorithm of a certificate, needs to replace the issuing authority of a certificate, or needs to replace the keys.

In summary, there is the following technical problem in the prior art: the existing implementation method generally presets the digital certificates in the device, thus the operators cannot remotely update the digital certificates in the home gateway. When the operators need to replace the digital certificates, unless on-site service, the digital certificates cannot be updated.

This approach has a certain risk and also brings serious problems.

### SUMMARY OF THE INVENTION

FIG. 1 shows a diagram of the service connection between the network management server and the home gateway, the network management server 11 and the home gateway 12 based on the connection relationship shown in FIG. 1 cannot remotely update the digital certificates in the home gateway.

To solve the technical problem, the present invention provides a method and system for managing digital certificates in a home gateway to remotely manage the digital certificates in the home gateway.

To solve the aforementioned problem, the present invention provides a method for managing digital certificate in a home gateway, a network management server sends certificate management information to the home gateway via the Technical Report-069.CPE WAN Management Protocol (TR069) packet, to remotely manage the digital certificates in the home gateway.

After the home gateway receives the TR069 packet, it manages the digital certificates as follows according to the certificate management information:

add digital certificates, update the digital certificates or delete the digital certificates.

The certificate management information comprises: digital certificate information object, and parameter information of the digital certificate information object;

wherein, the digital certificate information object is defined according to the TR069 protocol format.

The parameter information of the digital certificate information object comprises one or any combination of the following items:

Content (Content);

Certificate Type (Type);

Effective time (StartTime);

Expiration time (EndTime);

Digital certificate issuer parameter (IsUser); and

Digital certificate user parameter (User).

When adding a digital certificate, the method comprises:

the network management server uses the TR-069 protocol remote procedure to call method AddObject to require the home gateway to add a new instance of the digital certificate information object;

the network management server uses the TR-069 protocol remote procedure to call method SetParameterValues to set the parameter value of the content of the added example, so as to set the content of the added digital certificate; and

the network management server uses the TR-069 protocol remote procedure to call method SetParameterValues to set the parameter value of the certificate type (Type) of the added example, so as to set the certificate type of the added certificate.

When updating the digital certificates, the method comprises:

from all the instances of the digital certificate information object, the network management server determines the one corresponding to the digital certificate to be updated, and uses the TR-069 protocol remote procedure to call method SetParameterValues to set the information parameter value of the digital certificate to be updated, and the information parameter value comprises StartTime and EndTime.

When deleting digital certificates, the method comprises:

from all the instances of the digital certificate information object, the network management server determines the one corresponding to the digital certificate to be deleted, and uses the TR-069 protocol remote procedure to call method DeleteObject to require the home gateway to delete the instance corresponding to the digital certificate to be deleted.

When the network management server determines the instance corresponding to the digital certificate to be updated, the method also comprises:

verify the correctness of the digital certificate content.

In addition, the present invention also provides a system for managing digital certificate in a home gateway, and the system comprises a network management server, and the network management server comprises a certificate management decision module,

the certificate management decision module is set to, send certificate management information to the home gateway via the Technical Report-069.CPE WAN Management Protocol (TR069) packet, to remotely manage the digital certificates in the home gateway.

The system also comprises a home gateway, and the home gateway comprises a certificate management implementation module,

the certificate management implementation module is set to, after receiving the TR069 packet, manage the digital certificates as follows according to the certificate management information:

add digital certificates, update the digital certificates or delete the digital certificates.

The certificate management decision module is also set to, define the digital certificate information object according to the TR069 protocol format, and the certificate management information comprises: the digital certificate information object, and parameter information of the digital certificate information object;

the parameter information of the digital certificate information object comprises one or any combination of the following items:

content (Content);

certificate Type (Type);

effective time (StartTime);

expiration time (EndTime);

digital certificate issuer parameter (IsUser); and

digital certificate user parameter (User).

The certificate management decision module is also set to add digital certificates according to the following way:

use the TR-069 protocol remote procedure to call method AddObject to require the home gateway to add a new instance of the digital certificate information object;

use the TR-069 protocol remote procedure to call method SetParameterValues to set the parameter value of the added Example content, so as to set the content of the added digital certificate; and

use the TR-069 protocol remote procedure to call method SetParameterValues to set the parameter value of the certificate type (Type) of the added instance, so as to set the certificate type of the added certificate; and/or

update the digital certificates according to the following way:

from all the instances of the digital certificate information object, determine the one corresponding to the digital certificate to be updated, and use the TR-069 protocol remote procedure to call method SetParameterValues to set the information parameter value of the digital certificate to be updated, and the information parameter value comprises StartTime and EndTime; and/or

delete digital certificates according to the following way:

from all the instances of the digital certificate information object, determine the one corresponding to the digital certificate to be deleted, and use the TR-069 protocol remote procedure to call method DeleteObject to require the home gateway to delete the instance corresponding to the digital certificate to be deleted.

Compared with the prior art, the beneficial effects of the present invention are:

the present invention provides a solution for remotely managing the digital certificates, and the solution specifically comprises adding, updating, and deleting the digital certificates in the home gateway, so that when the digital certificate of an operator changes, the digital certificates in the user's home gateway can be remotely and directly updated, thus to make up the defect that the operator cannot update the certificate after delivery; moreover, with the technical solution of the present invention, the operators can more easily and quickly replace the digital certificates to make up the defects in the prior art.

### BRIEF DESCRIPTION OF DRAWINGS

FIG. 1 is a diagram of service connection between the network management server and the home gateway;

FIG. 2 is a flow chart of remotely managing the digital certificates in a home gateway in an application example of the present invention;

FIG. 3 is a diagram of a system for managing digital certificates in a home gateway in accordance with an embodiment of the present invention.

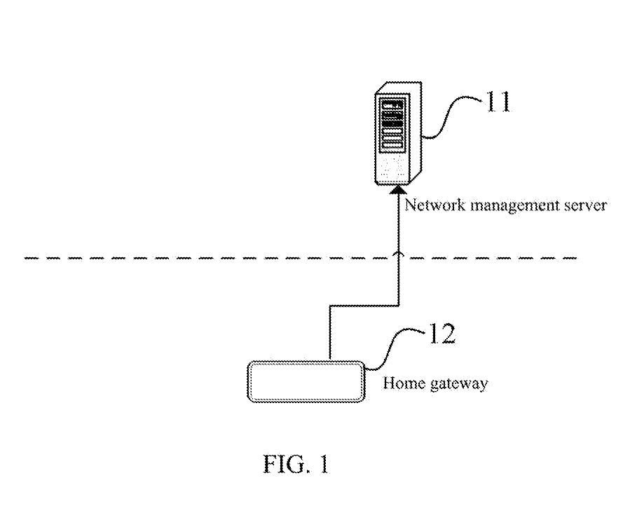

### PREFERRED EMBODIMENTS OF THE PRESENT INVENTION

The basic idea of the present invention is as follows: the network management server remotely sends a packet to the home gateway via the TR-069 protocol, the packet comprises the objects and parameters for managing the digital certificates in the home gateway, and these objects and parameters are defined according to the standard TR069 protocol format; the home gateway manages the digital certificates according to the objects and parameters in the received packet.

Based on the above idea, the present invention provides a method for managing digital certificates in a home gateway, and the following technical solution is used:

the network management server sends the certificate management information to the home gateway via the TR069 packet;

after the home gateway receives the packet, it manages the digital certificates according to the certificate management information in the packet.

The certificate management information comprises: digital certificate information object, the parameter information of the digital certificate information object.

The digital certificate information object is defined according to TR069 protocol format.

Managing the digital certificates comprises:

adding digital certificates, updating the digital certificates or deleting the digital certificates.

The implementation of the technical solution of the present invention will be described in further detail in the following with combination of specific examples and the accompanying figures.

Since there might be a plurality of certificates in the home gateway, the management of the digital certificates in the home gateway relates to the following information:

1. the number of digital certificates in the home gateway, that is, how many digital certificates in the home gateway there are;

2. the basic information of each digital certificate, that is, the file information of the digital certificate;

3. content of the digital certificates, such as issuing authority, effective date, expiration date, where the information can be directly extracted from the digital certificate file content;

4. types of the digital certificates, which is now generally divided into the root certificates, intermediate certificates;

5. the usage illustration of the digital certificates, for example, the certificate is used by the TR069 to connect the ACS or used wirelessly, and so on.

Based on the above management needs, in order to remotely update the digital certificates in the home gateway, in the embodiment of the present invention, the TR-069 protocol should be necessarily extended, comprising:

add two new objects in the TR-069 protocol:

Digital management object InternetGatewayDevice.X_ZTE_CertConfig.

Digital certificate information object InternetGatewayDevice.X_ZTE_CertConfig.CertInfo.

The content and parameters of the two objects are described in the following table 1:

TABLE 1

| Name | Type | Writable | Readable | Description |
|---|---|---|---|---|
| InternetGatewayDevice.X_ZTE_CertConfig. | Object | No | Yes | Digital certificate management object |
| CertNumberOfEntries | Parameter | No | Yes | The number of digital certificates in |
| | (unsigned | | | the device |
| | int) | | | |
| InternetGatewayDevice.X_ZTE_CertConfig.CertInfo.{i}. | Object | Yes | Yes | Digital certificate information object |
| IsUser | Parameter | No | Yes | Digital certificate issuer (issuing |
| | (String | | | authority) |
| | (64)) | | | |
| User | Parameter | No | Yes | Digital certificate user (institute) |
| | (String | | | |
| | (64)) | | | |
| StartTime | Parameter | No | Yes | Effective date |
| | (DateTime) | | | |
| EndTime | Parameter | No | Yes | Expiration date |
| | (DateTime) | | | |
| Type | Parameter | No | Yes | Certificate type, enumeration values |
| | (string) | | | are: |
| | | | | “Intermediate Certificate” |
| | | | | “Root certificate” |
| Content | Parameter | Yes | Yes | Certificate content, whose value can |
| | (String(10 | | | be directly changed so as to change |
| | K)) | | | the digital certificate. |

Refer to Table 1, the digital management object comprises the following parameters:

the number of digital certificates in the device: CertNumberOfEntries.

The digital certificate information object is an instance of the digital management object, and it comprises the following parameters:

Digital certificate issuer (issuing authority) parameter: IsUser;

Digital certificate user (institution) parameter: User;

Effective Date parameter: StartTime;

Expiration date parameter: EndTime;

Certificate type parameter: Type;

Certificate content parameter: Content.

The parameter type of the digital certificate issuer (organization) parameter and the digital certificate user (organization) parameter is 64-bit string (String (64));

the parameter type of the effective date parameter and the expiration date parameter is Date (DateTime);

the parameter type of the certificate type parameter is string, and the enumeration values are:

“Intermediate Certificate”

“Root certificate”

the parameter type of the certificate content parameter is String (10K), and the parameter value can be directly changed to update the digital certificate.

In the following, the specific implementation steps of remotely managing the digital certificates in the home gateway in accordance with the present invention will be described in more detail.

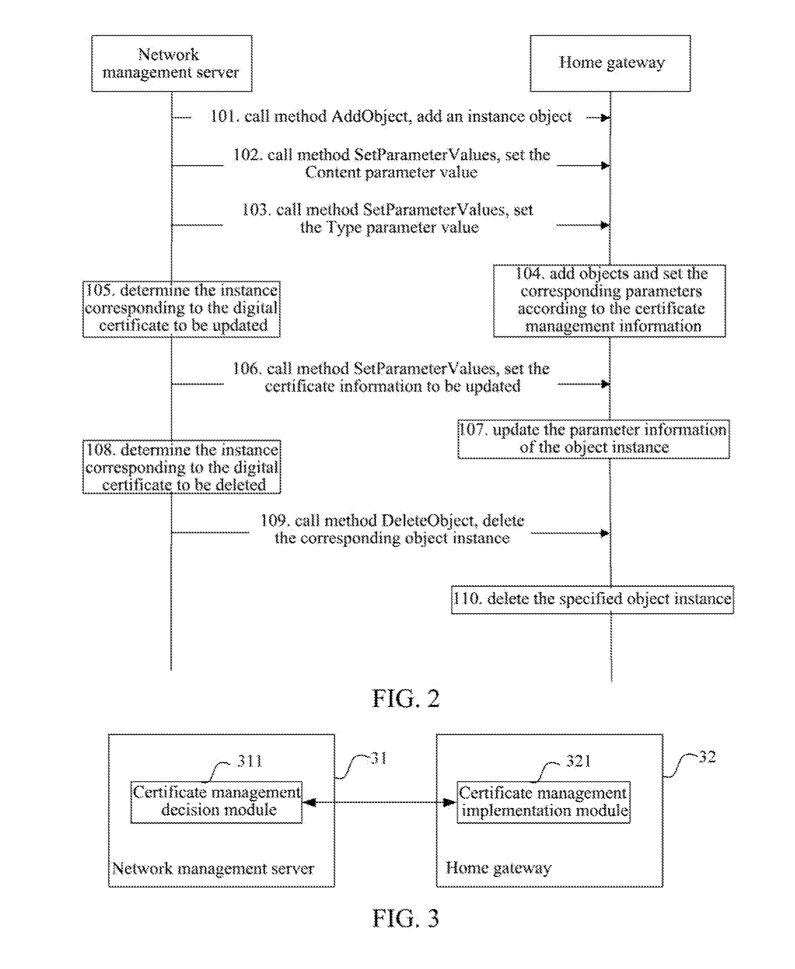

FIG. 2 shows the three main processes of remotely managing the digital certificates in the home gateway in accordance with the present invention, and the three main processes are: adding new digital certificates, updating the digital certificates, and deleting one or more digital certificates.

As shown in FIG. 2, the specific process of remotely managing the digital certificates in the home gateway in this example will be described in the following:

A. the process of adding new digital certificates, specifically comprising:

step 101, the network management server (or ACS) using the TR-069 remote procedure to call method AddObject to require the home gateway to add a new instance of the digital certificate information object InternetGatewayDevice.X_ZTE_CertConfig.CertInfo.;

step 102, using the TR-069 protocol remote procedure to call method SetParameterValues to set the Content parameter value of the instance added in step 101, so as to set the content of the certificate;

step 103, using the TR-069 protocol remote procedure to call method SetParameterValues to set the Type parameter value of the instance added in step 101, so as to set the type of the added certificate;

step 104, the home gateway adding the corresponding instance based on the certificate management information such as the objects and parameters sent by the network management server, and setting the corresponding parameters;

B. the process of updating the existing digital certificates, specifically comprising:

step 105, determining an instance to which the certificate to be updated corresponds from all the instances of the object InternetGatewayDevice.X_ZTE_CertConfig.CertInfo.;

step 106, using the TR-069 protocol remote procedure to call method SetParameterValues to set the parameter information, such as the effective time and the expiration time, of the certificate to be updated;

step 107, the home gateway updating the corresponding parameter information of the instance;

C. the process of deleting a digital certificate, specifically comprising:

step 108, determining an instance to which the certificate to be deleted corresponds from all the instances of the object InternetGatewayDevice.X_ZTE_CertConfig.CertInfo.;

step 109, using the TR-069 protocol remote procedure to call method DeleteObject to delete the certificate instance in the home gateway;

step 110, the home gateway deleting the certificate instance.

In addition, when the network server or the ACS updates the digital certificates, it can also verify the content of the digital certificates, so as to ensure the correctness of the content of the digital certificates.

Correspondingly, the embodiment of the present invention also comprises a system for managing digital certificate in a home gateway, as shown in FIG. 3, the system comprises the network management server 31, and the network management server 31 further comprises the certificate management decision module 311, wherein,

the certificate management decision module is set to, send certificate management information to the home gateway via the TR069 packet, to remotely manage the digital certificates in the home gateway.

In addition, the system also comprises the home gateway 32, and the home gateway 32 further comprises the certificate management implementation module 321,

the certificate management implementation module is set to, after receiving the TR069 packet, manage the digital certificates as follows according to the certificate management information:

adding digital certificates, updating the digital certificates or deleting the digital certificates.

In addition, the certificate management decision module is also set to: define the digital certificate information object according to the TR069 protocol format, and the certificate management information comprises: digital certificate information object, and parameter information of the digital certificate information object;

wherein, the parameter information of the digital certificate information object comprises one or any combination of the following items:

Content (Content);

Certificate Type (Type);

Effective time (StartTime);

Expiration time (EndTime);

Digital certificate issuer parameter (IsUser); and

Digital certificate user parameter (User).

In addition, the certificate management decision module is also set to,

add digital certificates according to the following way:

the network management server uses the TR-069 protocol remote procedure to call method AddObject to require the home gateway to add a new instance of the digital certificate information object;

the network management server uses the TR-069 protocol remote procedure to call method SetParameterValues to set the content parameter value of the added instance, so as to set the content of the added digital certificate; and

the network management server uses the TR-069 protocol remote procedure to call method SetParameterValues to set the parameter value of the certificate type (Type) of the added instance, so as to set the certificate type of the added certificate;

update the digital certificates according to the following way:

from all the instances of the digital certificate information object, the network management server determines the one corresponding to the digital certificate to be updated, and uses the TR-069 protocol remote procedure to call method SetParameterValues to set the information parameter value of the digital certificate to be updated, and the information parameter value comprises StartTime and EndTime; and/or

delete the digital certificates according to the following way:

from all the instances of the digital certificate information object, the network management server determines the one corresponding to the digital certificate to be deleted, and uses the TR-069 protocol remote procedure to call method DeleteObject to require the home gateway to delete the instant corresponding to the digital certificate to be deleted.

It can be understood by those skilled in the field that some or all steps in the abovementioned method can be fulfilled by instructing the relevant hardware components with a program, and said program is stored in a computer readable storage media such as read only memory, magnetic disk or optical disk. Optionally, all or some steps of the aforementioned embodiment can be implemented with one or more integrated circuits. Correspondingly, each module/unit in the aforementioned embodiment can be implemented in the form of hardware or software function module. The present invention is not limited to any combination of specific hardware and software forms.

The above description is the preferred embodiment of the present invention and is not intended to limit the present invention, and for those skilled in the field, the present invention has a variety of modifications and variations. Without departing from the spirit and essence of the present invention, all these types of modification, equivalences and improvements should belong to the scope of the claims of the present invention.

### INDUSTRIAL APPLICABILITY

The method and system for remotely managing the digital certificates provided in the present invention specifically comprise adding, updating, and deleting the digital certificates in the home gateway, so that when the digital certificate of an operator changes, the digital certificates in the user's home gateway can be remotely and directly updated, thus to make up the defect that the operator cannot update the certificate after delivery.

What is claimed is:

1. A method for managing digital certificates in a home gateway, comprising: a network management server sending certificate management information to the home gateway via a Technical Report-069.CPE WAN Management Protocol (TR069) packet, to remotely manage digital certificates in the home gateway.

2. The method of claim 1, wherein, the method also comprises:
after the home gateway receives the TR069 packet, the home gateway managing the digital certificates as follows according to the certificate management information in the packet:
adding digital certificates, updating digital certificates or deleting digital certificates.

3. The method of claim 1, wherein,
the certificate management information comprises: a digital certificate information object, and parameter information of the digital certificate information object;
wherein, the digital certificate information object is defined according to the TR069 protocol format.

4. The method of claim 3, wherein, the parameter information of the digital certificate information object comprises one or any combination of following items:
content (Content);
certificate Type (Type);
effective time (StartTime);
expiration time (EndTime);
digital certificate issuer parameter (IsUser); and
digital certificate user parameter (User).

5. The method of claim 4, wherein,
when adding a digital certificate, the method comprises:
the network management server using TR-069 protocol remote procedure to call method add-object (AddObject) to require the home gateway to add a new instance of the digital certificate information object;
the network management server using TR-069 protocol remote procedure to call method set-parameter-values (SetParameterValues) to set the content (Content) parameter value of the added instance, so as to set the content of the added digital certificate; and
the network management server using the TR-069 protocol remote procedure to call method SetParameterValues to set the certificate type (Type) parameter value of the added instance, so as to set the certificate type of the added certificate.

6. The method of claim 4, wherein,
when updating the digital certificates, the method comprises:
from all the instances of the digital certificate information object, the network management server determining one instance corresponding to a to-be-updated the digital certificate, and using the TR-069 protocol remote procedure to call the method SetParameterValues to set information parameter values of the to-be-updated digital certificate, and the information parameter value comprising effective time (StartTime) and expiration time (EndTime).

7. The method of claim 4, wherein,
when deleting digital certificates, the method comprises:
from all the instances of the digital certificate information object, the network management server determining one instance corresponding to a to-be-deleted digital certificate, and using TR-069 protocol remote procedure to call method delete-object (DeleteObject) to require the home gateway to delete the instance corresponding to the to-be-deleted digital certificate.

8. The method of claim 6, wherein, when the network management server determines the instance corresponding to the to-be-updated digital certificate, the method also comprises:
verifying correctness of the content of the digital certificate.

9. A system for managing digital certificates in a home gateway, wherein the system comprises a network management server, and the network management server comprises a certificate management decision module,
the certificate management decision module is set to, send certificate management information to the home gateway via a Technical Report-069.CPE WAN Management Protocol (TR069) packet, to remotely manage the digital certificates in the home gateway.

10. The system of claim 9, wherein, the system also comprises a home gateway, and the home gateway comprises a certificate management implementation module,
the certificate management implementation module is set to, after receiving the TR069 packet, manage the digital certificates as follows according to the certificate management information in the packet:
adding digital certificates, updating digital certificates or deleting digital certificates.

11. The system of claim wherein,
the certificate management decision module is also set to, define the certificate management information according to the TR069 protocol format, and the certificate management information comprises: a digital certificate information object, and parameter information of the digital certificate information object;
wherein, the parameter information of the digital certificate information object comprises one or any combination of following items:
content (Content);
certificate type (Type);
effective time (StartTime);
expiration time (EndTime);
digital certificate issuer parameter (IsUser); and
digital certificate user parameter (User).

12. The system of claim 11, wherein,
the certificate management decision module is also set to,
add digital certificates according to a following way:
using TR-069 protocol remote procedure to call method add-object (AddObject) to require the home gateway to add a new instance of the digital certificate information object;
using TR-069 protocol remote procedure to call method set-parameter-values (SetParameterValues) to set the content (Content) parameter values of the added instance, so as to set the content of the added digital certificate; and
using the TR-069 protocol remote procedure to call method SetParameterValues to set parameter values of the certificate type (Type) of the added instance, so as to set the certificate type of the added certificate; and/or
update digital certificates according to a following way:
from all the instances of the digital certificate information object, determining one instance corresponding to a to-be-updated digital certificate, and using the TR-069 protocol remote procedure to call method SetParameterValues to set information parameter values of the to-be-updated digital certificate, and the information parameter value comprising effective time StartTime and EndTime; and/or
delete digital certificates according to a following way:
from all the instances of the digital certificate information object, determining one instance corresponding to a to-be-deleted digital certificate, and using TR-069 protocol remote procedure to call method delete-object (DeleteObject) to require the home gateway to delete the instance corresponding to the to-be-deleted digital certificate.

13. The method of claim 2, wherein,
the certificate management information comprises: a digital certificate information object, and parameter information of the digital certificate information object;
wherein, the digital certificate information object is defined according to the TR069 protocol format.

14. The system of claim 10, wherein,
the certificate management decision module is also set to, define the certificate management information according to the TR069 protocol format, and the certificate management information comprises: a digital certificate information object, and parameter information of the digital certificate information object;
wherein, the parameter information of the digital certificate information object comprises one or any combination of following items:
content (Content);
certificate type (Type);
effective time (StartTime);
expiration time (EndTime);
digital certificate issuer parameter (IsUser); and
digital certificate user parameter (User).
